(19) United States
(12) Patent Application Publication
(10) Pub. No.: US 2024/0183286 A1
(43) Pub. Date: Jun. 6, 2024

(54) METHOD FOR MANUFACTURING GAS TURBINE ROTOR HEAT SHIELDING SEGMENT BY THREE-DIMENSIONAL PRINTING

(71) Applicants: Hyun Ki Kang, Busan (KR); Taek Ho CHUNG, Busan (KR); Sam Sub BYUN, Busan (KR); Jong Yeob LEE, Busan (KR); Jae Wha SON, Busan (KR); Kyeong Seung SHIN, Gimhae-si (KP); Gi Joo YANG, Busan (KR)

(72) Inventors: Hyun Ki Kang, Busan (KR); Taek Ho CHUNG, Busan (KR); Sam Sub BYUN, Busan (KR); Jong Yeob LEE, Busan (KR); Jae Wha SON, Busan (KR); Kyeong Seung SHIN, Gimhae-si (KP); Gi Joo YANG, Busan (KR)

(21) Appl. No.: 18/371,697

(22) Filed: Sep. 22, 2023

(30) Foreign Application Priority Data
Dec. 2, 2022 (KR) 10-2022-0166528

(51) Int. Cl. F01D 25/12; B33Y 40/00; B33Y 80/00

(52) U.S. Cl. CPC F01D 25/12; B33Y 40/00; B33Y 80/00; B33Y 10/00; F05D 2220/32; F05D 2230/31; F05D 2260/231

(57) ABSTRACT

The present invention relates to a method for manufacturing a gas turbine rotor heat shielding segment, which is mounted on a rotor outer wall between a compressor and a turbine and shields the leakage of heat and gas so that gas of high-temperature and high-pressure is not transferred from a burner of a gas turbine to a rotor shaft during the operation of the gas turbine, and more specifically, to a method for manufacturing a gas turbine rotor heat shielding segment by three-dimensional printing, wherein a portion having a simplified shape is manufactured by casting, and a portion having a complex shape is manufactured by 3D printing.

### BACKGROUND OF THE INVENTION

### Field of the Invention

The present invention relates to a method for manufacturing a gas turbine rotor heat shielding segment, which is mounted on a rotor outer wall between a compressor and a turbine and shields the leakage of heat and gas so that gas of high-temperature and high-pressure is not transferred from a burner of a gas turbine to a rotor shaft during the operation of the gas turbine, and more specifically, to a method for manufacturing a gas turbine rotor heat shielding segment by three-dimensional printing, wherein a portion having a simplified shape is manufactured by casting, and a portion having a complex shape is manufactured by 3D printing.

### Background Art

High-temperature components of a gas turbine operate for a long period of time under harsh conditions of high temperature and pressure, especially, at a high turbine inlet temperature (TIT) of 1100 to 1600° C., so experience thermal vibration fatigue and degradation due to high-temperature creep. Therefore, superalloys with excellent mechanical properties, high resistance to creep, high corrosion resistance, and high oxidation resistance at high temperature are used.

For the superalloys, there are Hastelloy, IN 738, IN 792, IN 939, Rene 45, Rene 71, Rene 80, Rene 142, Mar M247, CM 247, ECY 768, CMSX-4, etc.

Among ingredients of the superalloys, aluminum (Al) and titanium (Ti) form gamma prime at high temperature to enhance the high-temperature properties. However, when damaged high-temperature turbine components are repaired by fusion welding, it causes cracks. Therefore, it is very important to adjust the heat input during welding.

In general, arc welding has a higher heat input than laser cladding. As seen in the graph indicating weld sensitivity depending on the aluminum content and the titanium content in FIG. 1, when arc welding is applied to alloys positioned above the line of aluminum (Al) 3 wt % and titanium (Ti) 6 wt %, such as IN 738, IN 939, Mar M247, etc., based on a boundary line, aging cracks occur due to the expansion of gamma prime.

Therefore, repair and manufacturing technologies using laser cladding, which has less heat input into the base material, are being developed.

A conventional manufacturing method relates to a process of manufacturing a rotor heat shield segment among the high-temperature components of a gas turbine. The conventional manufacturing method, as illustrated in FIG. 2, as vacuum casting, comprises the steps of: wax mold-->wax pattern injection-->tree assembly-->coating-->dewaxing-->sintering-->casting-->desanding-->cutting-->heat treatment. The conventional manufacturing method is very complex in manufacturing process, and especially, has high manufacturing costs due to bad casting of inclusions or air pockets in a groove portion coupled to the rotor.

To overcome the above problems, the present invention proposes a manufacturing method for a rotor heat shield segment, wherein an outer wall path part (flow channel) of a rotor through which gas of high temperature passes is manufactured by the conventional casting method, and groove portions of a front rail and a rear rail are manufactured by 3D laser cladding of superalloy layers, thereby reducing defects in the groove portions coupled to the rotor.

### PATENT LITERATURE

### Patent Documents

Patent Document 1: Korean Patent No. 10-2135442 (entitled “Ring segment and gas turbine including the same, granted on Jul. 13, 2020)
Patent Document 2: Korean Patent No. 10-2291801 (entitled “Ring segment and gas turbine including the same, granted on Aug. 13, 2021)
Patent Document 3: Korean Patent No. 10-2153065 (entitled “Ring segment and gas turbine including the same, granted on Sep. 1, 2020)
Patent Document 4: Korean Patent Publication No. 10-2126852 (entitled “Turbine vane, ring segment and gas turbine including the same, granted on Jun. 19, 2020)
Patent Document 5: Korean Patent No. 10-2178956 (entitled “Turbine vane, ring segment and gas turbine including the same, granted on Nov. 19, 2020)

### SUMMARY OF THE INVENTION

Accordingly, the present invention has been made to solve the above-mentioned problems occurring in the prior arts, and it is an object of the present invention to provide a method for manufacturing a gas turbine rotor heat shielding segment by three-dimensional printing, wherein a portion of the gas turbine rotor heat shielding segment having a simplified shape is manufactured by casting, and a portion having a complex shape is manufactured by 3D printing, thereby enhancing productivity by reducing material and processing costs.

To accomplish the above object, according to the present invention, there is provided a gas turbine rotor heat shielding segment by three-dimensional printing, wherein a portion of the gas turbine rotor heat shielding segment having a simplified shape is manufactured by casting, and a portion having a complex shape is manufactured by 3D printing.

As described above, the method for manufacturing a gas turbine rotor heat shielding segment by three-dimensional printing manufactures the portion of the gas turbine rotor heat shielding segment having the simplified shape by casting, and manufactures the portion having the complex shape by 3D printing, thereby enhancing productivity by reducing material and processing costs. In addition, the method for manufacturing a gas turbine rotor heat shielding segment by three-dimensional printing can manufacture the segment to have various shapes depending on the usage environment, since the gas turbine rotor heat shielding segment is manufactured by three-dimensional printing.

### BRIEF DESCRIPTION OF THE DRAWINGS

FIG. 1 is a graph showing crack sensitivity depending on the aluminum content and the titanium content.

FIG. 2 is a process chart showing a manufacturing process of a rotor heat shield segment by a conventional vacuum casting.

FIG. 3 is a process chart of a conventional gas turbine rotor heat shield segment.

FIG. 4 is a process chart showing a manufacturing process of a gas turbine rotor heat shield segment according to the present invention.

FIG. 5 is a perspective view of the gas turbine rotor heat shield segment according to the present invention.

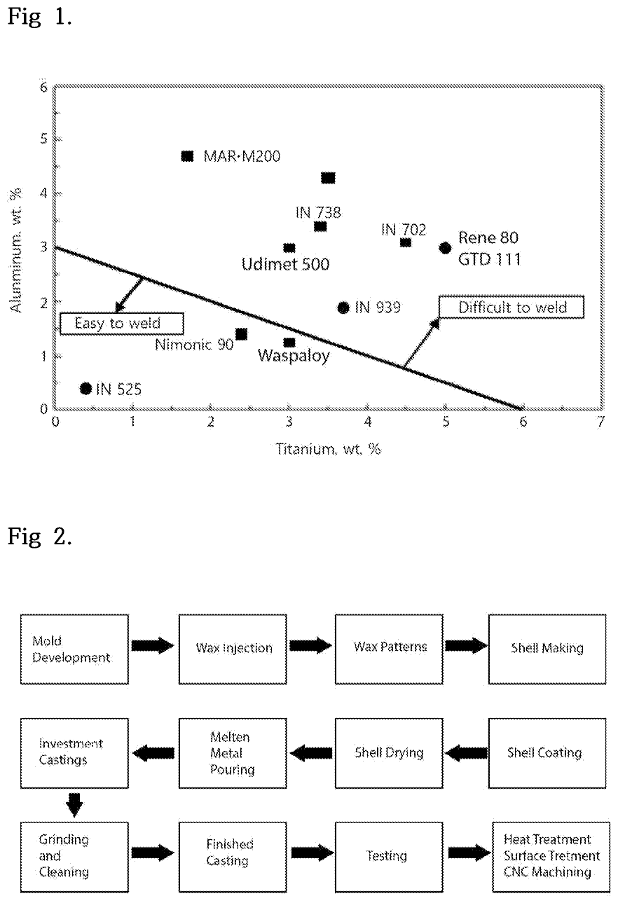

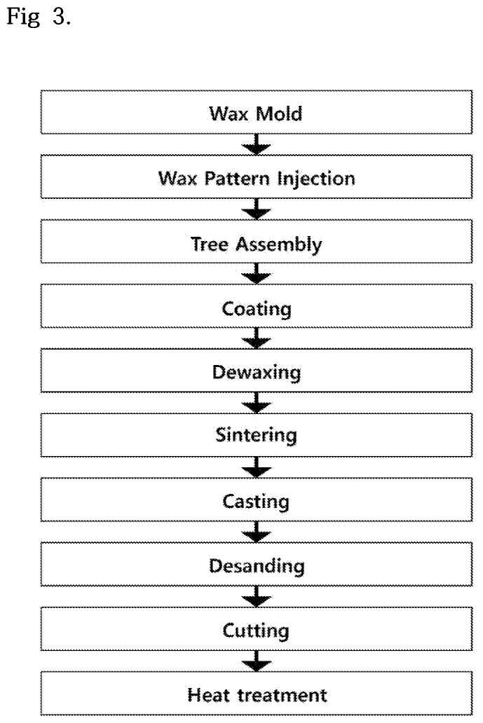

### DETAILED DESCRIPTION OF THE PREFERRED EMBODIMENT

A gas turbine rotor heat shielding segment by three-dimensional printing according to an embodiment of the present invention is characterized in that a gas turbine rotor heat shielding segment 100 is manufactured in such a way that a portion having a simplified shape is manufactured by casting and a portion having a complex shape is manufactured by 3D printing.

The gas turbine rotor heat shielding segment 100 includes a plate-shaped segment body 110 which has a plurality of cooling channels 150 formed internally, a hook part 120 and an endwall 130 which protrude at both left and right ends for coupling with other components, and a chamber 140, which is a space for introduction of compressed air and is formed on the upper surface of the segment body 110 by the hook part 120 and the endwall 130. The segment body 110 is manufactured by vacuum casting, and the remaining parts are manufactured by three-dimensional printing.

Moreover, the gas turbine rotor heat shielding segment 100 is manufactured by selecting one among a method that the remaining parts including the hook part 120 and the endwall 130 are manufactured by stacking on the upper surface of the segment body 110 by three-dimensional printing, and a method that the segment body 110 manufactured by casting and the remaining parts including the hook part 120 and the endwall 130 manufactured by three-dimensional printing are manufactured separately and are joined together by brazing.

Additionally, the gas turbine rotor heat shielding segment 100 is manufactured by selecting one among a method that the remaining parts including the hook part 120 and the endwall 130 are manufactured by stacking on the upper surface of the segment body 110 by three-dimensional printing, and a method that the segment body 110 manufactured by casting and the remaining parts including the hook part 120 and the endwall 130 manufactured by three-dimensional printing are manufactured separately and are joined together by brazing, and ultrasonic vibration can be applied to the gas turbine rotor heat shielding segment 100.

In addition, the gas turbine rotor heat shielding segment 100 is manufactured by selecting one among a method that the remaining parts including the hook part 120 and the endwall 130 are manufactured by stacking on the upper surface of the segment body 110 by three-dimensional printing, and a method that the segment body 110 manufactured by casting and the remaining parts including the hook part 120 and the endwall 130 manufactured by three-dimensional printing are manufactured separately and are joined together by brazing, and far-infrared rays can be applied to stacked powder.

Moreover, a plurality of reinforcing ribs 160 are formed between the hook part 120 and the endwall 130, and the reinforcing ribs 160 are manufactured by three-dimensional printing.

Hereinafter, a method for manufacturing a gas turbine rotor heat shielding segment by three-dimensional printing will be described in detail with reference to the attached drawings.

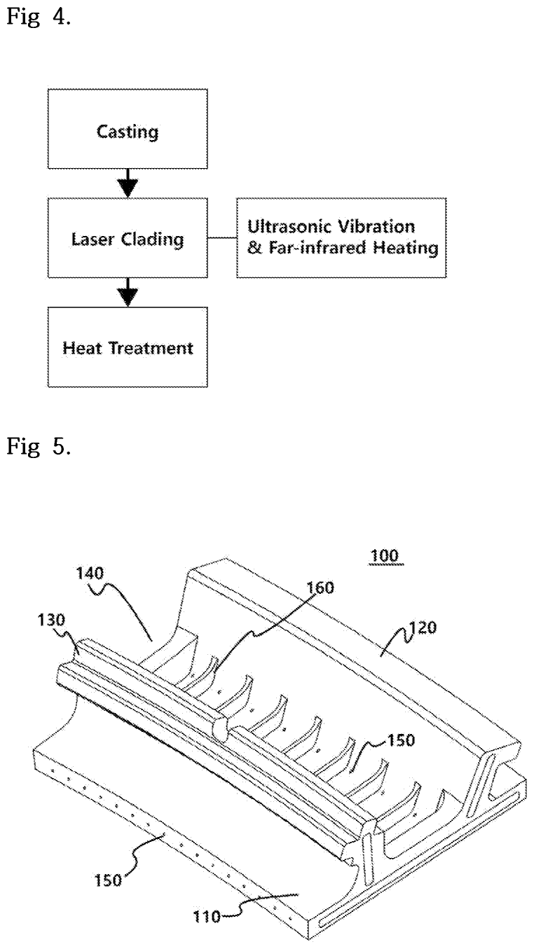

FIG. 4 is a process chart showing a manufacturing process of a gas turbine rotor heat shield segment according to the present invention, and FIG. 5 is a perspective view of the gas turbine rotor heat shield segment according to the present invention.

As illustrated in FIG. 5, the heat shield segment 100 includes a plate-shaped segment body 110 which has a plurality of cooling channels 150 formed internally, a hook part 120 which is joined to a casing and protrudes from one side end of the segment body 110, and an endwall 130 which is joined to a vane and is formed at the other side end of the segment body 110.

The rotor heat shield segment 100 has the hook part 120 and the endwall 130 for joining with other components, which protrude from both right and left ends of the plate-shaped segment body 110 having the plurality of cooling channels 150 formed internally.

Accordingly, due to the hook part 120 and the endwall 130, the chamber 140, which is a space for introduction of compressed air, is naturally formed on the upper surface of the segment body 110.

More preferably, in the present invention, a portion of the rotor heat shield segment 100 having a simplified shape is manufactured by casting and a portion having a complex shape is manufactured by 3D printing.

Specifically, the gas turbine rotor heat shielding segment 100 is manufactured by selecting one among a method that the remaining parts including the hook part 120 and the endwall 130 are manufactured by stacking on the upper surface of the segment body 110 by three-dimensional printing, and a method that the segment body 110 manufactured by casting and the remaining parts including the hook part 120 and the endwall 130 manufactured by three-dimensional printing are manufactured separately and are joined together by brazing.

Furthermore, ultrasonic vibration can be applied during stacking by 3D printing or joining by brazing.

The ultrasonic vibration is set to be within the range of 2 KHz to 100 MHZ.

Additionally, the stacking by 3D printing is carried out while maintaining the temperature of the segment body 110, which is the base material, within the range of 100 to 900° C. with the infrared wavelength within the range of 10 to 1000 μm.

More specifically, to transfer optimal ultrasonic vibration to a stacking area, a vibrator (not illustrated) is attached within 0.5 to 2000 mm far from the stacking area to provide vibration to the segment body 110, which is the base material, while performing stacking by 3D printing.

That is, the vibrator comes into contact with the surface of the segment body 110 within 0.5 to 2000 mm far from a welded point.

As described above, in a case in which the ultrasonic vibration and the three-dimensional printing are applied simultaneously to the stacking, it has an advantage in that mechanical properties, such as hardness, strength, wear, and fatigue, are increased since the porosity in the stacking area is reduced to 0.01% or less, and the size of the crystalline grains is reduced to 50% or less compared to the conventional laser cladding.

In the case of materials with a high melting temperature, such as Inconel superalloys, to adjust the solidification rate, the stacking by three-dimensional printing is performed while maintaining the temperature of the base material within the range of 100 to 900° C. using infrared heater wavelengths in the range of 10 to 1000 μm.

The three-dimensional printing method used for manufacturing the heat shield segment 100 is one selected from the stacking method through laser cladding and the stacking method through wire arc additive manufacturing (WAAM).

The method through wire arc additive manufacturing (WAAM) is a method that welds and stacks materials of a wire form using an arc heat source.

Furthermore, when the segment body 110 manufactured by vacuum casting and the remaining parts including the hook part 120 and the endwall 130 manufactured by three-dimensional printing through laser cladding are separately manufactured and are joined together by brazing, an insertion protrusion (not illustrated) is protrudingly formed at any one of end surfaces getting in contact with each other, and an insertion groove for insertion of the insertion protrusion is formed at an end surface of the other side corresponding to the insertion protrusion. Accordingly, the segment body and the remaining parts are assembled like Lego blocks, and then, joined by brazing, thereby maintaining stronger combination relation.

Moreover, to strengthen the segment body 110, the hook part 120, and the endwall 130, a plurality of reinforcing ribs 160 are formed between the hook part 120 and the endwall 130, and the reinforcing ribs 160 are manufactured by three-dimensional printing.

As described above, the method for manufacturing a gas turbine rotor heat shielding segment by three-dimensional printing manufactures the portion of the gas turbine rotor heat shielding segment having the simplified shape by casting, and manufactures the portion having the complex shape by 3D printing, thereby enhancing productivity by reducing material and processing costs. In addition, the method for manufacturing a gas turbine rotor heat shielding segment by three-dimensional printing can manufacture the segment to have various shapes depending on the usage environment, since the gas turbine rotor heat shielding segment is manufactured by three-dimensional printing.

What is claimed is:

1. A method for manufacturing a gas turbine rotor heat shielding segment by three-dimensional printing,
wherein the gas turbine rotor heat shielding segment includes a plate-shaped segment body which has a plurality of cooling channels formed internally, a hook part and an endwall which protrude at both left and right ends for coupling with other components, and a chamber which is a space for introduction of compressed air and is formed on the upper surface of the segment body by the hook part and the endwall, and the segment body, which is a portion having a simplified shape, is manufactured by vacuum casting and the remaining parts are manufactured by three-dimensional printing,
wherein the gas turbine rotor heat shielding segment is manufactured by selecting one among a method that the remaining parts including the hook part and the endwall are manufactured by stacking on the upper surface of the segment body by three-dimensional printing, and a method that the segment body manufactured by casting and the remaining parts including the hook part and the endwall manufactured by three-dimensional printing are manufactured separately and are joined together by brazing,
wherein the gas turbine rotor heat shielding segment is manufactured by selecting one among a method that the remaining parts including the hook part and the endwall are manufactured by stacking on the upper surface of the segment body by three-dimensional printing, and a method that the segment body manufactured by casting and the remaining parts including the hook part and the endwall manufactured by three-dimensional printing are manufactured separately and are joined together by brazing, and ultrasonic vibration of 2 KHz to 100 KHz can be applied,
wherein the gas turbine rotor heat shielding segment is manufactured by selecting one among a method that the remaining parts including the hook part and the endwall are manufactured by stacking on the upper surface of the segment body by three-dimensional printing, and a method that the segment body manufactured by casting and the remaining parts including the hook part and the endwall manufactured by three-dimensional printing are manufactured separately and are joined together by brazing, and far-infrared rays can be applied to stacked powder, wherein the stacking by three-dimensional printing is performed while maintaining the temperature of the base material within the range of 100 to 900° C. using infrared heater wavelengths in the range of 10 to 1000 μm,
wherein a plurality of reinforcing ribs are formed between the hook part and the endwall, and the reinforcing ribs are manufactured by three-dimensional printing, and
wherein when the segment body manufactured by vacuum casting and the remaining parts including the hook part and the endwall manufactured by three-dimensional printing through laser cladding are separately manufactured and are joined together by brazing, an insertion protrusion is protrudingly formed at any one of end surfaces getting in contact with each other, and an insertion groove for insertion of the insertion protrusion is formed at an end surface of the other side corresponding to the insertion protrusion, so that the segment body and the remaining parts are assembled like Lego blocks and are joined by brazing, thereby maintaining stronger combination relation.
